(19) United States
(12) Patent Application Publication
(10) Pub. No.: US 2005/0149742 A1
(43) Pub. Date: Jul. 7, 2005

(54) Biometric access method

(75) Inventor: Bernd X. Weis, Kontal-Munchingen (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/980,771

(22) Filed: Nov. 4, 2004

(30) Foreign Application Priority Data
Nov. 6, 2003 (EP) 03 292 806.1

(51) Int. Cl. H04K 1/00

(52) U.S. Cl. 713/186

(57) ABSTRACT

The invention concerns a biometric lock and a method for granting access to an object which is secured by such biometric lock. A terminal establishes a connection with an administration interface of the biometric lock via a communication network. An authorization procedure is executed in between the terminal and the biometric lock. If the authorization is positive, the biometric lock grants access to the administration interface. The terminal transfers biometric data of a new user, who shall be authorized to lock and/or unlock the biometric lock, to the biometric lock. It registers the new user and stores the received biometric data of the new user in a user registry. In the following, it compares actual received biometric data of a person requesting to access the object with the transfered biometric data. If the comparison is positive, the biometric lock is unlocked.

### TECHNICAL FIELD

The present invention relates to a method for granting access to an object, which is secured by a biometric lock, and to a biometric lock for granting access to such object. The invention is based on a priority application EP 03292806.1 which is hereby incorporated by reference.

### BACKGROUND OF THE INVENTION

For example, U.S. Pat. No. 2003/0141959 A1 discloses a fingerprint biometric lock. This biometric lock comprises a fingerprint sensor that detects a fingerprint pattern, a memory object that stores enrolled fingerprint code data and a verifying unit that determines whether an offered fingerprint code created from the fingerprint pattern sensed by the sensor matches with any of the enrolled fingerprint codes stored in the memory object. Further, the biometric lock has a motor controll unit that unlocks the locking mechanism and a finger presence detector for powering a direct current to the sensor and the motor control unit.

For the enrollment of a fingerprint, the user first presses a push button on the board. This action wakes up the CPU, turns on the fingerprint reader and sounds the beeper for a single beep. The CPU enables power to the fingerprint reader and engages it into an enroll mode. Now, the user has to press his finger to the finger print reader. After five seconds, the CPU turns off the fingerprint reader and indicates towards the user whether there was a valid finger print read or an invalid finger print.

JP 2001199311 A discloses a biometric lock for an automobile. This biometric lock is capable of permitting driving only for a right driver by inspecting whether or not a person is the right driver of the automobile by using biometric data. Acquiring means acquire signature data of a person who tries to drive the automobile. Inspection means inspect the acquired signature data to judge whether or not the data is signature data of a driving permitted right person. When judging that the data is not the signature data of the right person, the inspection means supplies an engine stopping signal to an engine lock means.

It is the object of the present invention to provide an improved biometric lock and an improved method for granting access to an object by such a biometric lock.

### SUMMARY OF THE INVENTION

The object of the present invention is achieved by a method for granting access to an object which is secured by a biometric lock, comprising the steps of: establishing a connection between a terminal and an administration interface of the biometric lock via a communication network; executing an authorization procedure between the terminal and the biometric lock; granting access to the administration interface of the biometric lock, if the authorization is positive; transferring biometric data to a new user, who shall be authorized to lock and/or unlock the biometric lock, from the terminal to the biometric lock via the communication network; registering the new user and storing the received biometric data of the new user in a user registry of the biometric lock; comparing, by the biometric lock, actually received biometric data of a person requesting to access the object with the transferred biometric data; and unlocking the biometric lock, if the comparison is positive. The object of the present invention is further achieved by a biometric lock for granting access to an object which is secured by the biometric lock, wherein the biometric lock comprising. A communication unit for establishment of connections between a terminal and an administration interface of the biometric lock via a communication network; a user registration unit adapted to execute an authorization procedure with a terminal, to grant access to the administration interface of the biometric lock, if the authorization is positive, to accept biometric data of a new user, who shall be authorized to lock and/or unlock the biometric lock, received from an authorized terminal, and to register the new user and to store the received biometric data of the new user in a user registry of the biometric lock; and a lock/unlock unit for comparing actually received biometric data of a person requesting to access the object with the received biometric data, and for unlocking said biometric lock, if the comparison is positive.

The invention provides a simple, powerful and user friendly solution to improve the granting of access by means of biometric means. No expensive infrastructure is necessary. Further, the safety and security of granting access to new users is increased. Further advantages are achieved by the embodiments indicated by the dependent claims.

Preferably, the terminal transmits as part of the authorization procedure biometric data of a person, who is registered in the registry as administrator, via the communication network to the biometric lock. The administrator authentifies itself vise versa the biometric lock by help of its biometric data. Thereby, you improve the safety and security, but also the user friendness of the system. The administrator has not to remember a specific PIN or TAN code (PIN=Personal Identification Number, TAN=Transaction Number). Further, it is possible for the biometetric lock to use a single authentication mechanism for both, the lock/unlock decision and the administrator access. This makes it possible to implement the biometric lock in a more simple and cheaper way.

Further, the terminal may emulate the administration interface of the biometric lock towards the administrator. It simulates the administration interface towards the administrator, which makes it more easier for the administrator to use this terminal as administration interface.

Already existing terminal may be reused to implement the invention. For example, a mobile phone terminal or a PDA (PDA=Personal Digital Assistant) comprising a cellular network communication unit can be used for such purpose. This opens the possibility of a cheap and powerful implementation of the invention. For example, a biometric lock emulation software package is downloaded via the communication network to such terminals, installed on the terminals and provides in the following the aforementioned functionalities.

Preferably, the terminal gathers the biometric data of the new user, who shall be authorized to lock and/or unlock the biometric lock, by means of a sensor located at the terminal. This increases the user friendness, the safety and security of the process. The biometric data may be entered at the attendance of both, the new user and the operator.

Further, the biometric lock can assign limited access rights and/or time dependent access rights to the new user. This provides an additional possibility to increase safety and security of the method.

Practically, the lock/unlock unit comprises a sensor for receiving biometric data for lock and/or unlock the object.

### BRIEF DESCRIPTION OF THE DRAWINGS

These as well as other features and advantages of the invention will be better appreciated by reading the following detailed description of presently preferred exemplary embodiments taken in conjunction with accompanying drawings of which:

FIG. 1 is a block diagram of a system's biometric lock according to the invention.

FIG. 2 is a functional view showing the details of a terminal and the biometric lock of FIG. 1.

### DETAILED DESCRIPTION OF PREFERRED EMBODIMENTS

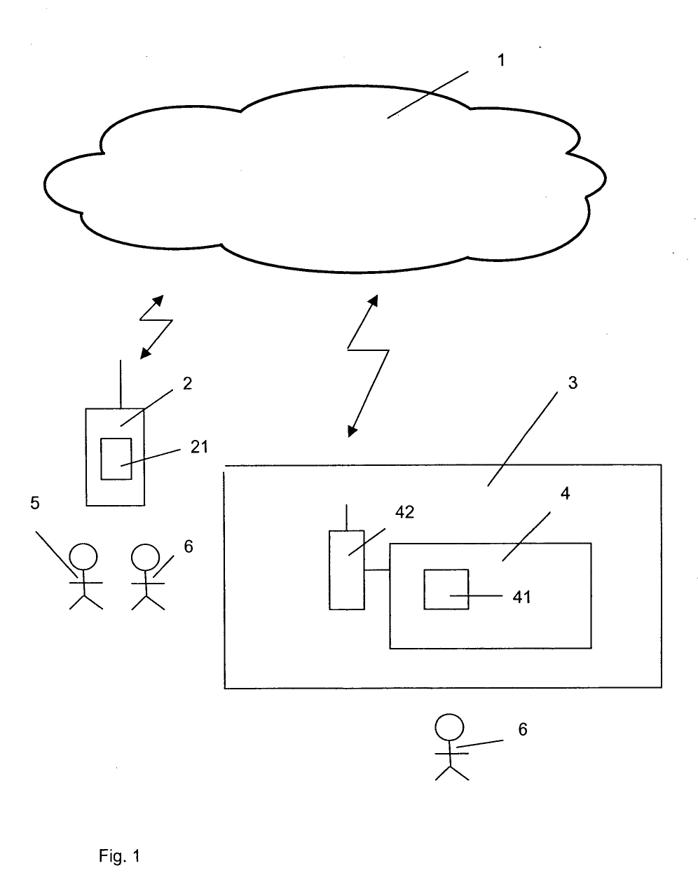

FIG. 1 shows a communication network 1, a terminal 2, an object 3, a biometric lock 4, and two persons 5 and 6.

The communication network 1 is a cellular phone network, for example, a GSM or UMTS network (GSM=Global System for Mobile Communication; UMTS=Universal Mobile Telecommunications System). But, it is also possible that the communication network 1 is a data network or a communication network constituted by a plurality of different physical interlinked networks.

The terminal 2 is a portable terminal, preferably a cellular phone as a phone according to the GSM or UMTS standard, or a PDA (PDA=Personal Digital Assistant) with wireless communication capabilities.

The object 3 is a vehicle, for example a car. But, it is also possible that the object is a secured storage system or a house, an apartment or room to which the movement is restricted. The biometric lock 4 restricts the access to the object 3. For example, it controls the lock/unlock of a door or cap or the lock/unlock of an engine. The biometric lock 4 is equipped with a sensor 41 for detecting biometric data of a person who likes to access the object 3. Biometric data can be fingerprint, iris structure, etc. Fingerprint is a very typical example for such biometric data which has already been used for ages in criminology to identify persons. Further, the biometric lock 4 is connected with a communication device 42. The communication device 42 has the capability to communicate via the communication network 1. For example, the communication device 42 is a mobile phone integrated in a car or connected via a mobile phone holder with the biometric lock 4. But, it is also possible that a communication unit having the capability to communicate via the communication network 1 is integrated in the biometric lock 4.

In the following, the invention is explained by hand of the following embodiment:

The object 3 is a car that identifies the user via fingerprint so that only those users registered in the biometric lock 4 can use the car. Now, a user wants to lend the car to a friend or a car rental agency wants to rent the car to a person—who is of course not registered in the biometric lock 4. For example, the person 5 is a person who can give rights to access the object 3, in the following called the administrator, and the person 6 is a person, who temporarily wants to use the car.

The person 5 access the registry of the biometric lock 4 using his own biometric information, for example his fingerprint. For this access, it uses the mobile phone 2 which plays the role of an emulator emulating the administration interface of the biometric lock 4. The mobile phone 2 has a fingerprint reader 21, which sensors the biometric data of the person 5 and converts this data in digital information. The mobile terminal 2 establishes via the communication network 1 a connection to the administration interface of the biometric lock 4. Then, it executes an authorization procedure with the biometric lock. As part of this authorization procedure, the terminal 2 transmits the digitized biometric data of the person 5 to the biometric lock 4. The biometrick lock 4 verifies this biometric data and grants access to the administration interface if these biometric data are assigned to a registered administrator.

Then, the person 5 passes the mobile phone 2 to the person 6. The fingerprint reader 21 sensors the fingerprint of the person 6 and digitizes this biometric information. Then, the terminal 2 transmits this digitized data via the communication network 1 to the biometric lock 4. The biometric lock 4 registers the person 6 as new user and stores the received biometric data of this new user in a user registry.

Later on, when the person 6 requests access to the car, the biometric lock 4 sensors the biometric data of the person 6, compares these actual received biometric data with the transferred biometric data stored in the user registry and unlocks the car, if the comparison is positive.

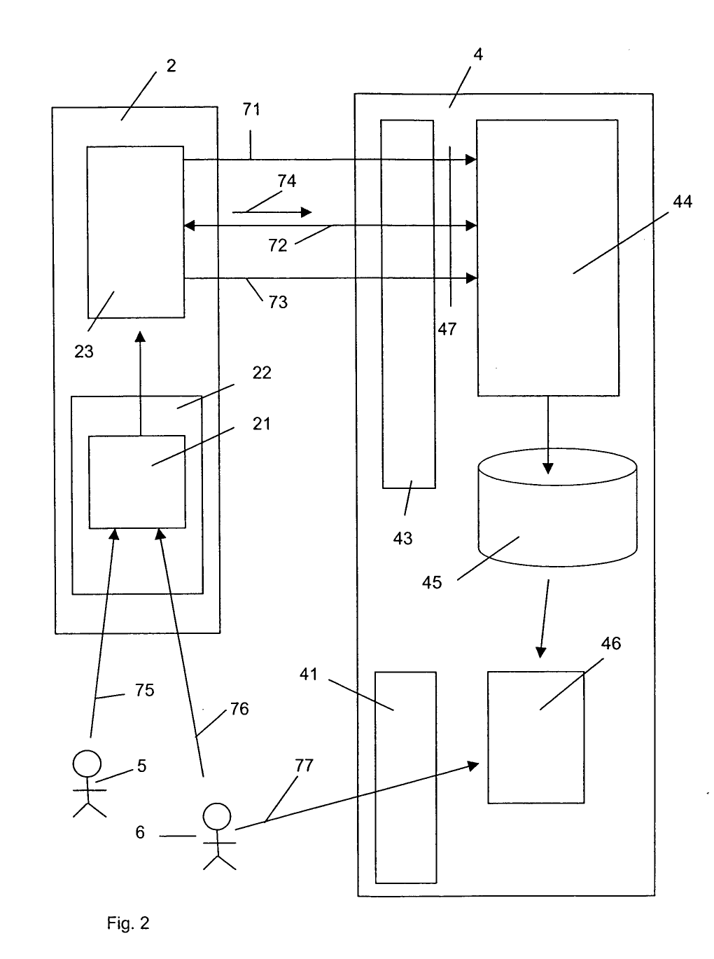

FIG. 2 points out a detailed embodiment of the invention:

FIG. 2 shows the terminal 2, the biometric lock 4 and the persons 5 and 6.

The terminal 2 is constituted by input and output objects, microprocessor, communication devices necessary for communicating via the communication network 1 and program code executed by the microprocessor. The functionalities of the terminal 2 are performed by the execution of this program code on the hardware platform provided by the other parts of the terminal 2. From the functional point of view, the terminal 2 comprises two units 22 and 23. The unit 22 comprises all the basic functionalities of the terminal 2, for example the functionaliites of a cellular mobile phone or PDA. The unit 23 comprises the additional specific functionalities for controlling the interaction with the biometric lock 4.

For example, the unit 23 is formed by a software package downloaded to the terminal 2 via the communication network 1. This software package can be encoded as a JAVA-Middlet executed on the software platform provided by the unit 22. Further, it is possible that this software package is preinstalled on the terminal 2 or is downloaded via a specific short distance interface, for example a bluetooth, infrared or galvanic interface to the terminal 2.

As shown by FIG. 2, the terminal 2 comprises the sensor 21. The sensor 21 is used for gather biometric data. For example, the sensor 21 is a scanner for scanning the fingerprint, the iris or the face of a person and translates these biometric information in digitized biometric data. Further, it is possible that the speech of a person is used as biometric data uniquely identifying this person. In this case, the sensor 21 can be formed by a microphone gathering the specific tongue of the person. Further, the sensor 21 or the unit 23 can perform a preprocessing of the digitized speech, for example calculating a set of speech coefficience used as biometric data of the person.

Preferably, the sensor 21 is an integrated part of the terminal 2. But, it is also possible that the sensor 21 is linked via a cable or a short range interface, for example a bluetooth interface, with the terminal 2. According to a further possibility, biometric data of the person 5 and/or 6 are transferred to the terminal 2 via the communication network 1 or are already stored in the terminal 2.

The biometric lock 4 is constituted by a microprocessor connected with several peripheral units and program code executed by this microprocessor. The functionalities of the biometric lock 4 are performed by the execution of this program code on the hardware platform constituted by the microprocessor and the peripheral units. From the functional point of view, the biometric lock 4 comprises a communication unit 43, a user registration unit 44, a registry 45, a lock/unlock unit 46 and a user interface unit 41.

The communication unit 43 comprises all functionalities necessary for communicating via the communication network 1. These functionalities comprise the functionalities of a typical cellular phone capable to establish connections over the communication network 1 and to process the associated communication protocol stacks. Further, it can comprise functionalities to handle further protocol stacks, which are, for example, necessary to communicate via a GPRS service or other kind of package oriented data communication service, higher protocol layers as WAP (Wireless Access Protocol), or security protocols supporting encryption of the data exchanged between the terminal 2 and the biometric lock 4.

The user registration unit 4 provides a user interface 47, which gives access to the administration and control functionalities of the biometric lock 4. It provides this administration interface 47 over the communication unit 43. In addition, the administration interface 47 may be provided via the user interface unit 41 to local use.

It is the main task of the user registration unit 44 to administrate the users of the biometric lock 4 and the access right granted to such users. It is responsible for the enrolment and removal of users. Further, it is responsible for the amendment and change of access rights of such users.

The user registry 45 is a storage unit which is used to store data sets assigned to registered users. For example, such a data set contains an identifier for identifying the user, several access right parameters describing the access rights granted to the users and a set of biometric data specifying the biometric data of the user.

The user interface unit 41 provides a physical user interface to potential users of the biometric lock:

For example the user interface unit 41 comprises a display, a keypad and a sensor for gathering-biometric data. Such sensor may be a sensor similar to the sensor already described in conjunction with the sensor 21. It can be a scanner for scanning the fingerprint, the iris or the face of a person who requests to access the object 3. In case of a speech based biometric lock, the sensor can be formed by a microphone and associated speech processing functions.

But, it is also possible that the user interface unit 41 is formed by a separate device connected with the biometric lock 4 via a cable, short range interface or communication network.

On a command entered by the person 5, the unit 23 establishes a communication connection between the terminal 2 and the administration interface 47 of the biometric lock 47 via the communication network 2. For example, the terminal 2 requests the establishment of a connection to a telephone number assigned to the administration interface 47 of the biometric lock 4. After establishment of the connection, the unit 23 sends a request message 71 to the user registration unit 44 which requests access to the administration interface 47. Then, an authorization procedure 72 is executed between the unit 23 and the user registration unit 44. As part of this procedure, the terminal 2 indicates a request message towards the person 5 that requests to enable the gathering of his biometric data by the sensor 21.

After scanning and digitization of the biometric data of the person 5, the unit 23 transfers this data as data 74 to the user registration unit 44. The user registration unit 44 compares the received biometric data 74 with biometric data stored in the registry 45. If this biometric data fits with stored biometric data that is associated with a registered user having administrator rights, the user registration unit 44 grants access to the administration interface 47. If not, it denies such access.

Further, it is possible that further authentication and authorization procedures are executed between the unit 23 and the user registration unit 44. For example, the unit 23 encrypts a random number transferred by the user registration unit 44 and the user registration unit 44 checks by help of the replied signed response whether the terminal 2 has the right to access the administration interface 47. Further possibilities are the transmission of a PIN code entered by the person 5. Further, it is possible that the transmission of the biometric data 74 is replaced by one of the above-described alternative authentication and authorization procedures.

After granting access to the administration interface, the person 5 has the possibility to access various administration operations via a graphical user interface presented by his terminal 2. This graphical user interface can have the same look and feel as the administration interface provided by the biometric lock 4 via the user interface unit 41.

If the person 5 intends to enroll the person 6 as new user who shall be authorized to lock and/or unlock the biometric lock 4, it passes the terminal 2 after reception of a corresponding request message to the person 6. This person is now requested by the terminal 2 to enable the gathering of his biometric data. This data is gathered by the sensor 21 and transferred by the unit 23 as biometric data 73 via the administration interface 47 to the user registration unit 44. The user registration unit 44 checks whether this data is received from an authorized terminal. If that is the case, the user registration unit 44 registers the new user and stores the received biometric data of the new user in the user registry 45. Further, it collects the corresponding data, for example user identity and access right parameters, from the unit 23. Such data can be entered by the person 5 or selected from a default data assigned to the person 5 within an associated user profile.

Further, the registration of the person 6 can depend on an explicit acknowledgment command entered by the person 5.

Preferably, the user registration unit 44 assigns limited access rights or time dependent access rights to the person 6. For example, the access rights of the person 6 are adapted to the car rental contract of the person 6.

In the following, the lock/unlock unit 46 compares the biometric data received from the user interface unit 41 with the biometric data of the person 6 received via the administration interface 47 and stored within the registry 45. If the comparison is positive, it unlocks the biometric lock. For example, it unlocks the door of a vehicle or unlocks the engine of a car so that it becomes possible for the person 6 to use a car or access an object.

1. A method for granting access to an object which is secured by a biometric lock,
wherein
the method comprises the steps of:
establishing a connection between a terminal and an administration interface of the biometric lock via a communication network;
executing an authorization procedure between the terminal and the biometric lock;
granting access to the administration interface of the biometric lock, if the authorization is positive;
transferring biometric data of a new user, who shall be authorized to lock and/or unlock the biometric lock, from the terminal to the biometric lock via the communication network;
registering the new user and storing the received biometric data of the new user in a user registry of the biometric lock;
comparing, by the biometric lock, actual received biometric data of a person requesting to access the object with the transferred biometric data; and
unlocking the biometric lock, if the comparison is positive.

2. The method of claim 1,
wherein
the method comprises the further step of transferring, as part of the authorization procedure, biometric data of a person, who is registered in the registry as administrator, from the terminal to the biometric lock via the communication network.

3. The method of claim 1,
wherein
the method comprises the further step of emulating, by the terminal, the administration interface of the biometric lock towards the administrator.

4. The method of claim 1,
wherein
the terminal is a mobile phone terminal.

5. The method of claim 1,
wherein
the terminal is a PDA.

6. The method of claim 1,
wherein
the method comprises the further step of downloading a biometric lock emulation software package via the communication network to the terminal.

7. The method of claim 1,
wherein
the method comprises the further step of gathering the biometric data of the new user, who shall be authorized to lock and/or unlock the biometric lock, by means of a sensor located at the terminal.

8. The method of claim 1,
wherein
the method comprises the further step of assigning limited access rights and/or time dependent access rights to the new user.

9. A biometric lock for granting access to an object which is secured by the biometric lock,
wherein
the biometric lock comprises: a communication unit for establishing connections between a terminal and an administration interface of the biometric lock via a communication network; a user registration unit adapted to execute an authorization procedure with a terminal, to grant access to the administration interface of the biometric lock, if the authorization is positive, to accept biometric data of a new user, who shall be authorized to lock and/or unlock the biometric lock, received from an authorized terminal, and to register the new user and to store the received biometric data of the new user in a user registry of the biometric lock; and
a lock/unlock unit for comparing actual received biometric data of a user requesting to access the object with the received biometric data, and for unlocking said biometric lock, if the comparison is positive.

10. The biometric lock of claim 9,
wherein
the lock/unlock unit comprises a sensor for receiving biometric data for lock and/or unlock the object.
